(19) United States
(12) Patent Application Publication
(10) Pub. No.: US 2006/0213293 A1
(43) Pub. Date: Sep. 28, 2006

(54) Device and method to create directed motion

(76) Inventors: Thorsten Lasch, Aspach (DE); Steffi Lasch, Aspach (DE)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/388,130

(22) Filed: Mar. 23, 2006

(30) Foreign Application Priority Data
Mar. 24, 2005 (EP) 05 006 506.9

(51) Int. Cl. F16H 27/04

(52) U.S. Cl. 74/84 S

(57) ABSTRACT

The invention relates to a drive to create directed motion along an advantageous direction (R) with a gyrating mass (m) that is mounted so that it may move along the advantageous direction (R) and may rotate about an axis (A). For this, a first drive medium is provided that is so configured that it exerts a first force (F1) on the gyrating mass (m) outside of its center of mass with at least one component parallel to the advantageous direction (R). Further, a second drive medium is provided exerts a second force on the center of mass of the gyrating mass (m) in opposition to the first force (F1). A drive system incorporating two or more such drives may be provided.

### TECHNICAL FIELD

The invention relates to a drive to create directed motion, and a corresponding method.

### BACKGROUND INFORMATION

State-of-the-Art drives, particularly for vehicles, are implemented in that initiation of motion of the vehicles is used against some medium to create propulsion. Ground vehicles, for example, are driven by initiation of motion with respect to the road surface; water vehicles (if motorized) obtain their propulsion by interaction with the water. Moreover, there are drives that convert rotational impulses into directed motion, thus creating propulsion. These, however, are relatively complex in design.

### SUMMARY

It is the task of the invention to propose a simple mechanism to provide directed motion that is of simple design, and for which initiation of motion against an exterior medium is not required.

According to the invention, force is exerted along the advantageous direction, i.e., the direction in which the driven system is to be moved, outside the center of mass of the gyrating mass. Because of this, the gyrating mass performs a translation motion against the advantageous direction, along with a rotational motion. During the rotational motion of the gyrating mass, a second force is exerted on the center of mass of the gyrating mass so that this force causes only a translation motion of the gyrating mass, thus providing a smaller contribution than the first force. Thus, a force that leads to directed motion of the system to be moved is exerted on the system (e.g., vehicle) as a result of the ‘action=reaction’ principle based on the first and second forces not being completely cancelled.

### BRIEF DESCRIPTION OF THE DRAWINGS

These and other features and advantages of the present invention will be better understood by reading the following detailed description, taken together with the drawings wherein:

FIG. 1 is one embodiment example for a drive based on the invention in a first operating position;

FIG. 2 shows the embodiment example from FIG. 1 in a second operating position; and

FIG. 3 shows the embodiment example from FIG. 1 in a third operating position.

### DETAILED DESCRIPTION OF THE PREFERRED EMBODIMENTS

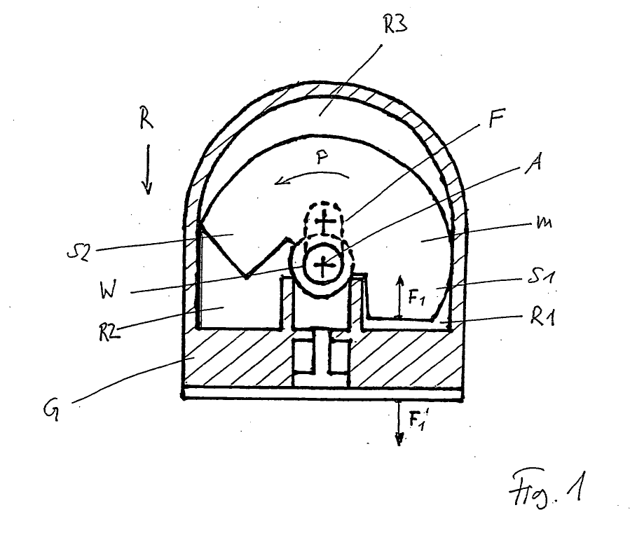

FIG. 1, for example, shows a drive that implements the principle on which the invention is based. The drive is mounted on the system (vehicle or similar) that is to be moved. In the example illustrated, a housing G is provided in which a half-moon shaped gyrating mass m is mounted, although other shapes for the gyrating mass m are conceivable. The housing G is preferably matched to the shape of the gyrating mass m. The gyrating mass m is mounted so that it may pivot about an axis A, whereby the axis A is preferably formed by a shaft W mounted within the housing G. Along with the pre-determined degree of rotational freedom, the gyrating mass m also possesses a degree of freedom of movement for translation. This translatory degree of freedom of movement exists with respect to the advantageous direction, i.e., the direction in which the system is to be moved by the drive. For this, the axis A or the shaft W is preferably inserted into a guide F in the housing extending along the advantageous direction R. Naturally, the translatory guide for the gyrating mass m may be configured differently.

The right leg S1 of the gyrating mass m shown in FIG. 1 is located in a space R1 within the housing G. The gyrating mass m is rotated about the axis in the direction of the arrow P by the exertion of a force F1 from a first drive on the right leg S1, and therefore outside the center of mass of the gyrating mass m.

The expansion of a fluid (i.e., of a gaseous or liquid medium) is preferably provided as the drive medium, but other drives are conceivable that are suited to setting the gyrating mass m in motion per the invention, for example an electromagnetic drive or similar.

Along with the rotational motion of the gyrating mass m, the gyrating mass m is moved by translation against the advantageous direction R whereby the rotation axis A is correspondingly displaced. In the example shown, this displacement is realized by insertion of the shaft W into the guide F. Exertion of the force F1 in the illustrated manner simultaneously exerts an opposing force F1′ of the same magnitude on the system connected to the drive, providing initial motion of the system along the advantageous direction R.

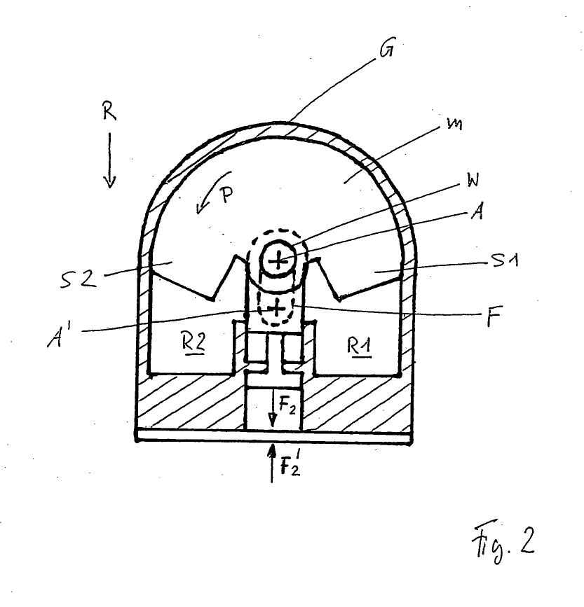

The inertia of the gyrating mass m causes it to be moved in the direction of the arrow P so that the left leg S2 of the gyrating mass m moves in the direction of the left space R2. Simultaneously, the gyrating mass m moves against the advantageous direction R so that it fills the space R3 with about half its motion. This situation is shown in FIG. 2. Here, the gyrating mass m has been moved by translation with respect to the direction of the force F1, whereby the rotation axis or the shaft W of the gyrating mass m has moved from position A′ to position A.

At the point at which the gyrating mass m continues to move in the direction of arrow P as a result of its inertia, a force F2 (that, as the first drive medium, may be implemented as an expanding fluid or, for example, as an electromagnetic drive) is exerted on the gyrating mass m in such manner that it takes action at the center of mass, so that it causes no torque on the gyrating mass m, but rather a translatory motion of the gyrating mass m against the advantageous direction. This force F2 resultantly holds the gyrating mass m ‘back,’ whereby it continues to rotate.

Since the force F2 begins to act so that no torque is exerted on the gyrating mass m, then the relationship between the force magnitudes F1 and F2 must be F2<F1. Thus, the opposing force F2′ caused by the force F2 is smaller than the opposing force F1′ caused by F1. When the forces F1 and F2, or F1′ and F2 , are added, there remains a component along the advantageous direction R that causes the system to begin to move.

This process is repeated according to the invention so that a permanent drive for the system results along the advantageous direction R. In the example shown, the gyrating mass m exerts a pendulum-like motion during which it oscillates between spaces R1 and R2.

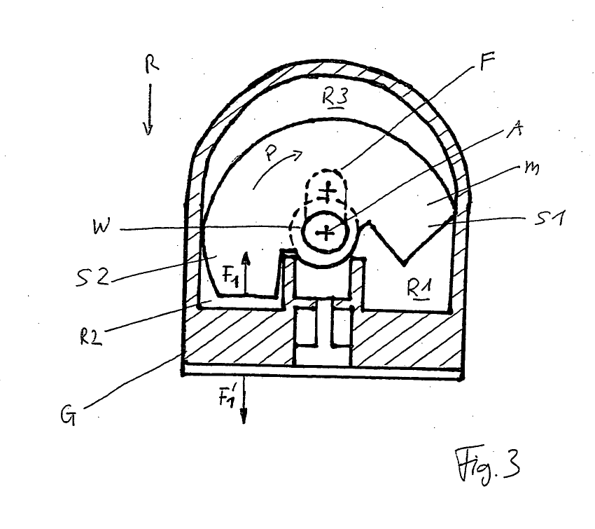

This is realized in the illustrated example in that when the second leg S2 of the gyrating mass m ends up in the space R2 because of its inertia, then the force F1 is again exerted on the gyrating mass m, but this time takes action on the second leg S2 so that the gyrating mass m moves along the direction of the arrow P. This is shown in FIG. 3. A translatory ‘return’ of the gyrating mass m by exertion of the force F2, as described in connection with FIG. 2. This process of alternating the exertion of the force F1 from the left leg S2 to the right leg S1 of the gyrating mass m, along with a constant exertion of the force F2 in opposition to F1 at the center of mass of the gyrating mass m subsequently provides for the constant drive of the system and its motion along the advantageous direction R.

In order to alter the rotational momentum of a gyrating mass m, the gyrating mass m (preferably outside the housing G) may be configured with additional supplementary masses.

In order to reduce the operating oscillation, or the rotational impulse on the system caused by the rotation of the gyrating mass m, a driven system might advantageously include several drives based on the invention. These drives are switched in such a manner that the rotational motions of the individual gyrating masses m cancel one another out.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claimed is:

1. A drive to create a directed motion along an advantageous direction (R) with a gyrating mass (m) that may move along the advantageous direction and about a rotation axis (A), whereby a first drive medium is provided that is so configured that it exerts a first force (F1) on the gyrating mass (m) outside its center of mass with at least a component parallel to the advantageous direction (R), and whereby a second drive medium is provided that exerts a second force (F2) on the gyrating mass (m) opposing the first force (F1) that acts on its center of mass.

2. A drive as in claim 1, wherein the drive includes a housing (G) to accept the gyrating mass (m).

3. A drive as in claim 2, wherein the gyrating mass (m) includes a half-moon shaped body that is mounted on a shaft (W) so that it may rotate.

4. A drive as in claim 3, wherein the housing (G) includes a guide (F) extending along the advantageous direction (R) to accept the shaft (W).

5. A drive as in claim 4, wherein at least one additional supplemental mass is provided on the shaft (W) adjacent to the gyrating mass (m) or outside the housing (G).

6. A drive as in claim 1, wherein the first and/or second drive medium includes an expanding gas.

7. A drive as in claim 1, wherein the first or second drive medium includes an electromagnetic drive.

8. A drive system as in claim 1 including at least two of said drives.

9. A method to create directed motion of a body, particularly a vehicle, along an advantageous direction (R) by means of at least one drive, said drive including at least one gyrating mass (m) that may move along the advantageous direction and about a rotation axis (A), whereby a first drive medium is provided that is so configured that it exerts a first force (F1) on the gyrating mass (m) outside its center of mass with at least a component parallel to the advantageous direction (R), and whereby a second drive medium is provided that exerts a second force (F2) on the gyrating mass (m) opposing the first force (F1) that acts on its center of mass, said method including the acts of:
exerting a first force (F1) on said at least one gyrating mass (m) parallel to the advantageous direction (R) in a translatory manner, said gyrating mass (m) mounted so that it may rotate about an axis (A) outside its center of mass, so that the gyrating mass (m) performs a translatory and a rotational motion; and
exerting a second force (F2) opposing the first force (F1) on the gyrating mass (m) at its center of mass, so that the gyrating mass (m) performs a translatory motion.

10. The method as in claim 9, wherein said drive system includes at least two said drives and wherein the exertion of the first and second force is so configured that the rotational motion of each gyrating mass (m) opposes the other(s).
